(19) United States
(12) Patent Application Publication
(10) Pub. No.: US 2020/0168957 A1
(43) Pub. Date: May 28, 2020

(54) Lead Battery Arrangement And Process For Regenerating A Lead Battery Arrangement

(71) Applicant: Kurt Wolfert, Harrison, OH (US)

(72) Inventor: Kurt Wolfert, Harrison, OH (US)

(21) Appl. No.: 16/405,464

(22) Filed: May 7, 2019

(30) Foreign Application Priority Data
Nov. 28, 2018 (DE) 10 2018 130 190.1

(51) Int. Cl. H01M 10/42

(52) U.S. Cl. CPC H01M 10/4242; H01M 10/08

(57) ABSTRACT

Battery arrangements and methods of operating a battery arrangement. The battery arrangement includes at least two cells each including at least two electrodes at least partially immersed in an electrolyte, and a regeneration device for regenerating the electrolyte. The regeneration device is configured so that a volume of electrolyte in the first cell or the second cell can be exchanged with a regenerated electrolyte or a depleted electrolyte depending on an operating condition of the battery arrangement.

### CROSS-REFERENCE TO RELATED APPLICATIONS

This application claims the benefit of priority under 35 U.S.C. § 119(a) to German Patent Application DE 10 2018 130 190.1, filed Nov. 28, 2018 (pending), the disclosure of which is hereby incorporated by reference in its entirety.

### TECHNICAL FIELD

The invention concerns a lead battery arrangement lead battery arrangement including at least two cells each having two lead electrodes and at least partially surrounded by an electrolyte.

### BACKGROUND

Although lead batteries have a relatively low energy density, they are inexpensive and very reliable. In this respect, lead batteries are also considered useful for electric mobility.

Lead batteries have an enclosure in which at least two electrodes are arranged. In most cases, the lead battery has more than two electrodes grouped into cells having a separator between the electrodes, and the electrolyte is based on diluted sulfuric acid.

During the discharging process, lead sulfate is deposited on both the negative electrode and the positive electrode, and the content of sulfuric acid in the electrolyte is decreased. During the charging process, the lead sulfate is broken down on the electrodes and sulfuric acid is released into the electrolyte. This may be done, for example, by applying a voltage across the two electrodes. Due to the chemical reaction required for regeneration, the charging process takes some time. During this time, the battery is not fully available to provide power to an electrical load.

### SUMMARY

The invention solves the problem of providing a lead battery arrangement that may be regenerated in a short period of time.

The lead battery arrangement includes at least two cells each having two lead electrodes that are at least partially surrounded by an electrolyte, as well as a regeneration device for regenerating the electrolyte. The lead battery arrangement is designed so the depleted electrolyte in a cell may be removed and replaced by a regenerated electrolyte. Preferably, the electrolyte is based on diluted sulfuric acid.

Lead batteries have been utilized for a long time with diluted sulfuric acid as an electrolyte. In an electrolyte based on diluted sulfuric acid, the regenerated electrolyte differs from the depleted electrolyte in that the regenerated electrolyte has a higher content of sulfuric acid. By replacing the depleted electrolyte, sulfuric acid is again available and thus the state of charge of the cells is restored.

Due to the possibility of replacing the depleted electrolyte with a regenerated electrolyte, the service life increases, and the battery arrangement reaches its full potential.

This battery arrangement requires a smaller number of cells to provide the same range or service life as conventional arrangements, therefore utilizing less weight and increasing cost savings as compared to conventional lead batteries.

The regeneration device of the lead battery arrangement may include a first storage container for depleted electrolytes and a second storage container for regenerated electrolytes. The cells are preferably connected to the first storage container via one fluid line and to the second storage container via another fluid line. The storage containers in conjunction with the fluid lines enable a quick replacement of depleted or regenerated electrolyte in the cells. Depleted electrolyte may be transported into the first storage container via the first fluid line, while regenerated electrolyte fills the cells via the second fluid line.

A plurality of storage containers may also be provided for depleted and regenerated electrolytes.

The volumes of the individual storage containers may be designed to optimize and expedite the refilling process.

The appropriate volume of electrolyte necessary to fill a battery or a stack of batteries may be available per storage container. The depleted electrolyte may be removed from the battery and placed into the first storage container. Regenerated electrolyte may flow into the battery from the second storage container. After the exchange, the first storage container may be fully filled, and the entire volume of electrolyte in the battery regenerated. The second storage container, on the other hand, may be empty.

The capacity of the first storage container and the second storage container may preferably be larger than the volume of the cells of the required electrolyte. As a result, for example, a larger amount of electrolyte may be absorbed in the first storage container. Cells may be recharged multiple times with regenerated electrolyte. Due to the greater capacity of the second storage container, electrolyte, which is depleted several times, may be extracted from the cells. For a mobile application, this may increase the longevity and enable movement over a greater distance.

Several first and second storage containers may be placed in row, so that the range of the battery increases significantly.

An increased removal rate of the depleted electrolyte may be enabled by a conveyor device, or “pump” arranged in the first fluid line. The pump may be built as a suction pump, or any other suitable type of pump that enables the depleted electrolyte to be removed from the cells quickly.

Another pump may be arranged in the second fluid line that enables the regenerated electrolyte from the second storage container to quickly flow into the cells. Each pump may convey the electrolyte, for example, by mechanical action.

The first fluid line and the second fluid line may be used with a valve system including one or more valves. The valve system may be configured to selectively fluidically couple one or more input ports to one or more output ports in response to signals from a control unit. To this end, the valve system may comprise a rotary valve having a transverse plug coupled to a motor. The motor may cause the valve system to fluidically couple a selected input port to a selected output port by rotating the transverse plug to one of a plurality of predetermined positions. In an alternative embodiment of the invention, the valve system may comprise a plurality of valves that are configured to provide the desired selective fluidic coupling in response to signals from the control unit. In this alternative embodiment, the valve system may include a plurality of valves connected to a manifold. The valve system enables a targeted opening and closing of the first fluid line and the second fluid line and ensures that there is no exchange of electrolyte between discharged and charged cells. The valve system selectively directs depleted or regenerated electrolyte between the cells and the first storage container or the second storage container.

The first and the second pumps, the valve system, and the cells may be operatively connected to the control unit. Based on a nominal voltage across the electrodes of a cell connected to an electrical load, the control unit may determine the cell is discharged. In response to this determination, the control unit may disconnect the electrical load from the electrodes of the discharged cell and connect the electrical load to the electrodes of another cell, e.g., by activating one or more relays or other switches that selectively connect the electrodes of the cells to the electrical load. In an alternative embodiment of the invention, the charge level of the cell may be determined based on a characteristic of the electrolyte, e.g., the specific gravity of the electrolyte.

The control unit may connect and activate the first pump and the second pump and adjust the valve system in such a way that depleted electrolyte is conveyed to or from the discharged cell to the first storage container by the first pump, and regenerated electrolyte is conveyed to or from the cell to the second storage container by the second pump.

In this respect, the control unit enables the cells to be regenerated automatically. Due to the fact that charged cells are always available for the electrical load, an uninterrupted supply of electrical energy is possible. Therefore, such a lead battery arrangement is suitable, for example, to power an electric vehicle.

In addition to replacing the electrolyte, regeneration is also possible by applying an outside electrical voltage to the electrodes. The voltage breaks down lead sulfate deposited on the electrodes and releases sulfuric acid into the electrolyte. Preferably, such regeneration of lead batteries may occur using solar cells that are electrically connected to the electrodes. A regeneration of the lead batteries by replacing the electrolyte may occur in this design if the solar cells are unable to provide sufficient electrical energy. In either case, the lead batteries may be completely regenerated. Alternatively, or in addition, regeneration may occur by wind power.

The process of regeneration of the lead battery arrangement may include removing depleted electrolyte from the cells when the electrical nominal voltage between the electrodes falls below a predetermined threshold value.

The depleted electrolyte may be removed from the cell, and a supply of regenerated electrolyte placed into the cell, with the regenerated electrolyte having a higher proportion of sulfuric acid than the depleted electrolyte.

Several cells may be grouped together into a stack. This arrangement may comprise at least two enclosures which operate alternately, with the cells from one stack providing electrical energy while the cells of the other stack undergo a regeneration.

Regeneration of a stack may be started if the nominal voltage of the cells of the stack connected to the electrical load drops below 1.95 V.

The lead battery arrangement may include an electrical energy device that provides electrical energy, e.g., an electric generator, photocell, or other electrical energy device. The electrical energy device may preferably be connected to the electrodes of the cells of the two stacks. The electrical energy device may include solar cells, a wind turbine, or a generator, for example. The electrical energy device may be stationary or mobile. In the case of a mobile design, the device may be assigned to the vehicle with a lead battery arrangement. As a result, depending on the environmental conditions, the electrical energy device may enable a regeneration process while driving, e.g., by converting kinetic energy of the vehicle into electrical energy during braking.

Depending on the operating conditions, the energy provided by the electrical energy device may be larger than the energy demand of the electrical load connected to the lead battery arrangement. In this case, it is conceivable that the stack which is currently connected to the electrical load can also be regenerated.

The above summary presents a simplified overview of some embodiments of the invention to provide a basic understanding of certain aspects of the invention discussed herein. The summary is not intended to provide an extensive overview of the invention, nor is it intended to identify any key or critical elements or delineate the scope of the invention. The sole purpose of the summary is merely to present some concepts in a simplified form as an introduction to the detailed description presented below.

### BRIEF DESCRIPTION OF THE DRAWINGS

The accompanying drawing, which is incorporated in and constitute a part of this specification, illustrate various embodiments of the invention and, together with the general description of the invention given above, and the detailed description of the embodiments given below, serve to explain the embodiments of the invention.

FIG. 1 is a diagrammatic view of an exemplary lead battery arrangement (e.g., for a vehicle) in accordance with an embodiment of the invention.

### DETAILED DESCRIPTION

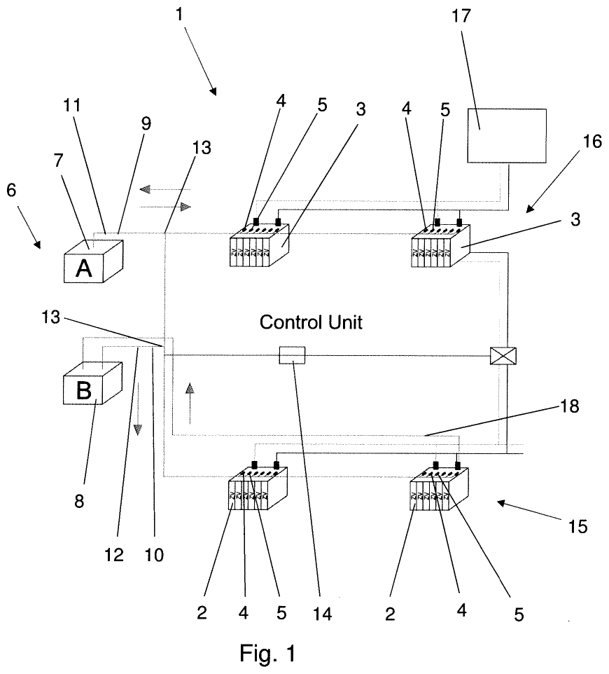

FIG. 1 shows a lead battery arrangement (1) including a plurality of lead batteries. Each lead battery contains at least one cell (2), (3), in which at least two lead electrodes (4), (5) are arranged. The electrodes (4), (5) are at least partially immersed in an electrolyte of diluted sulfuric acid. Several cells (2), (3) may be arranged in a stack (15), (16), and the depicted lead battery arrangement (1) includes two stacks (15), (16).

The number of cells (2), (3) per stack (15), (16) may depend on the amount of the energy to be provided. In a larger vehicle, each stack may contain more cells than a stack of a smaller vehicle.

In the depicted embodiment, a first stack (15) is connected to an electric load, such as an electric vehicle, while the second stack (16) goes through a regeneration cycle.

The lead battery arrangement (1) also includes a regeneration device (6), which may include a first storage container (7) for depleted electrolytes and a second storage container (8) for regenerated electrolytes. The cells (2), (3) of stacks (15), (16) may be connected to the first storage container (7) via a first fluid line (9) and to the second storage container (8) via a second fluid line (10). A first pump (11) may be situated in the first fluid line (9), and a second pump (12) may be situated in the second fluid line (10). In addition, fluid lines (9), (10) may be equipped with a valve system (13) that enables alternate emptying and filling of cells (2), (3) with electrolyte from the first and second storage containers (7), (8).

The first and second pumps (11), (12) as well as the valve system (13) may be connected to a control unit (14). The control unit (14) may detect the nominal voltage of the cells (2), (3). A regeneration cycle may be triggered by the nominal voltage of the cells (2), (3) of the stack (15) connected to the electric load falling below a threshold value, e.g., 1.95 V. The regeneration cycle may cause the control unit (14) to disconnect the discharged stack (15) from the electrical load and connect a charged stack (16) to the electrical load so that electricity is provided to the electrical load without interruption. The depleted electrolyte may then be removed from the cells (2) of the discharged stack (15). To this end, the depleted electrolyte may be emptied by the first pump (11) and the first fluid line (9) and placed into the first storage container (7). The cells (2) of the depleted stack (15) may then be filled with regenerated electrolyte from the second storage container (8) via the second fluid line (10) and the second pump (12). As a result, the nominal voltage of the cells (2) of the first stack (15) may increase again, so that the stack (15) can be connected to the electrical load as soon as the nominal voltage in the cells (3) of the second stack (16) drops below the threshold value.

Lead battery arrangement (1) may be arranged in an electrically powered vehicle and used to provide electrical energy for the vehicle's electric propulsion motor.

Lead battery arrangement (1) may also include an electrical energy device (17) that is selectively connected to the electrodes (4), (5) of the cells (2), (3) of the two stacks (15), (16) to provide electrical energy thereto. The electrical energy device (17) may include solar cells, a wind turbine, or both solar cells and a wind turbine, and may be stationary or mobile. The electrical energy device (17) may also include a generator, which may be powered by an engine or by kinetic energy recovered from the vehicle. In the case of a mobile design, the electrical energy device (17) may be assigned to a vehicle so that, depending on the environmental conditions, a regeneration process during the journey is also possible.

Depending on conditions, the energy provided by the electrical energy device (17) may be greater than the power demanded by the electrical load connected to the lead battery. In this case, the stack (15), (16) connected to the electrical load may be regenerated, depending on the amount of power demanded by the electrical load.

Depending on the power demanded by the connected electrical load, it is also conceivable that both stacks (15), (16) may simultaneously provide electrical energy to the electrical load.

If sufficient electrical energy is provided by the electrical energy device (17), the regeneration process may proceed inversely. In this case, depleted electrolyte from the first storage container (7) may be provided to the cells (3) of the stack (16) that is not connected to the electrical load. The charging process may enrich the electrolyte in the cells (3) of stack (16) with sulfuric acid. The regenerated electrolyte from the cells (3) of the stack (16) may then be provided to the second storage container (8) and another regeneration process carried out. To this end, in response to the nominal voltage of the cells (3) of stack (16) rising above another threshold (e.g., 2.10 volts), the control unit may cause the valve system (13) and/or pumps to convey the regenerated electrolyte in the cells (3) of the stack (16) to the second storage container (8) and refill the cells (3) with depleted electrolyte from the first storage container (7).

Storage containers (7), (8) and electrical energy device (17) may be part of a regeneration device (6) that is stationary. Lead battery arrangement (1), on the other hand, may be arranged in a vehicle.

In this case, regeneration of lead batteries may occur by replacing depleted electrolyte with electrolyte stored outside the vehicle. Because regeneration requires only the replacement of the depleted electrolyte with a regenerated electrolyte, regeneration may take place in a very short time.

In this case, replacement of the depleted electrolyte may be analogous to the operation of filling a tank of a vehicle having an internal combustion engine. Electrolyte may also be circulated under pressure between the storage container (8) and the stacks through fluid lines (9) and (10). The pressurization may elicit greater electrical potential and cause the process of discharging from the sulfuric acid to take longer, thereby increasing available energy to the electric load.

Embodiments of the invention described above, or portions thereof (e.g., the central controller), may be implemented using one or more computer devices or systems. Computers may include a processor, a memory, an input/output (I/O) interface, and a Human Machine Interface (HMI). The processor may include one or more devices selected from microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on operational instructions that are stored in memory.

Memory may include a single memory device or a plurality of memory devices including, but not limited to, read-only memory (ROM), random access memory (RAM), volatile memory, non-volatile memory, static random access memory (SRAM), dynamic random access memory (DRAM), flash memory, cache memory, or data storage devices such as a hard drive, optical drive, tape drive, volatile or non-volatile solid state device, or any other device capable of storing data.

The processor may operate under the control of an operating system that resides in memory. The operating system may manage computer resources so that computer program code embodied as one or more computer software applications, such as an application residing in memory, may have instructions executed by the processor. One or more data structures may also reside in memory, and may be used by the processor, operating system, or application to store or manipulate data.

The I/O interface may provide a machine interface that operatively couples the processor to other devices and systems, such as the electrodes, pumps, valve system, switches, etc., of the lead battery arrangement. The application may thereby communicate via the I/O interface to provide the various features, functions, applications, processes, or modules comprising embodiments of the invention.

The HMI may be operatively coupled to the processor to allow a user to interact directly with the computer. The HMI may include video or alphanumeric displays, a touch screen, a speaker, and any other suitable audio and visual indicators capable of providing data to the user. The HMI may also include input devices and controls such as an alphanumeric keyboard, a pointing device, keypads, pushbuttons, control knobs, microphones, etc., capable of accepting commands or input from the user and transmitting the entered input to the processor.

The terminology used herein is for the purpose of describing particular embodiments only and is not intended to be limiting of the embodiments of the invention. As used herein, the singular forms “a”, “an” and “the” are intended to include both the singular and plural forms, and the terms “and” and “or” are each intended to include both alternative and conjunctive combinations, unless the context clearly indicates otherwise. It will be further understood that the terms “comprises” or “comprising,” when used in this specification, specify the presence of stated features, integers, actions, steps, operations, elements, or components, but do not preclude the presence or addition of one or more other features, integers, actions, steps, operations, elements, components, or groups thereof. Furthermore, to the extent that the terms “includes”, “having”, “has”, “with”, “comprised of”, or variants thereof are used in either the detailed description or the claims, such terms are intended to be inclusive in a manner similar to the term “comprising”.

While all the invention has been illustrated by a description of various embodiments, and while these embodiments have been described in considerable detail, it is not the intention of the Applicant to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of the Applicant's general inventive concept.

What is claimed:

1. A battery arrangement comprising:
a first cell including a first plurality of electrodes and a first volume of electrolyte; and
a regeneration device configured to selectively exchange a respective volume of electrolyte in the first cell with a depleted electrolyte or a regenerated electrolyte.

2. The battery arrangement of claim 1 wherein the regeneration device includes a first storage container that holds the depleted electrolyte, and a second storage container that holds the regenerated electrolyte.

3. The battery arrangement of claim 2 wherein the regeneration device further includes:
a first fluid line connecting the first cell to the first storage container, and
a second fluid line connecting the first cell to the second storage container.

4. The battery arrangement of claim 3 wherein the regeneration device further includes:
a first pump configured to convey the depleted electrolyte through the first fluid line; and
a second pump configured to convey the regenerated electrolyte through the second fluid line.

5. The battery arrangement of claim 4 wherein at least one of the first pump and the second pump is configured to circulate the respective electrolyte through the first cell under pressure.

6. The battery arrangement of claim 2 further comprising:
a second cell including a second plurality of electrodes and a second volume of electrolyte, and wherein the regeneration device further includes:
a valve system that selectively fluidically couples at least one of the first cell or the second cell to one or both of the first storage container and the second storage container.

7. The battery arrangement of claim 6 wherein the first cell is connected to an electric load, and the regeneration device further includes:
a control unit in communication with the valve system and configured to:
in response to a nominal voltage between the electrodes of the first cell falling below a first predetermined threshold value, switching the electric load from the first cell to the second cell; and
causing the valve system to convey the first volume of electrolyte from the first cell to the first storage container, and to convey the regenerated electrolyte from the second storage container to the first cell.

8. The battery arrangement of claim 7 wherein the control unit is further configured to:
in response to the nominal voltage between the electrodes of the first cell rising above a second predetermined threshold value, cause the valve system to convey the first volume of electrolyte from the first cell to the second storage container, and to convey the depleted electrolyte from the first storage container to the first cell.

9. The battery arrangement of claim 1 wherein each electrode includes lead.

10. The battery arrangement of claim 1 wherein the electrolyte includes sulfuric acid.

11. A method of operating a battery arrangement comprising:
selectively exchanging a first volume of electrolyte of a first cell including a first plurality of electrodes with a depleted electrolyte or a regenerated electrolyte.

12. The method of claim 11 wherein exchanging the first volume of electrolyte further includes one or more of:
adding or removing the depleted electrolyte from a first storage container, and
adding or removing the regenerated electrolyte from a second storage container.

13. The method of claim 12 wherein exchanging the first volume of electrolyte further includes one or more of:
conveying the depleted electrolyte through a first fluid line connecting the first cell to the first storage container, and
conveying the regenerated electrolyte through a second fluid line connecting the first cell to the second storage container.

14. The method of claim 13 wherein conveying the depleted electrolyte through the first fluid line includes activating a first pump and conveying the regenerated electrolyte though the second fluid line includes activating a second pump.

15. The method of claim 14 wherein conveying at least one of the depleted electrolyte or the regenerated electrolyte comprises circulating the respective electrolyte through the first cell under pressure.

16. The method of claim 12 wherein exchanging the first volume of electrolyte further includes causing a valve system to selectively fluidically couple the first cell to one or more of the first storage container and the second storage container.

17. The method of claim 16 wherein the first cell is connected to an electric load, and further comprising:
in response to a nominal voltage of between the electrodes of the first cell falling below a first predetermined threshold value, switching the electric load from the first cell to a second cell; and
causing the valve system to convey the first volume of electrolyte from the first cell to the first storage container, and to convey the regenerated electrolyte from the second storage container to the first cell.

18. The method of claim 17 further comprising:
in response to the nominal voltage between the electrodes of the first cell rising above a second predetermined threshold value, causing the valve system to convey the first volume of electrolyte from the first cell to the second storage container, and to convey the depleted electrolyte from the first storage container to the first cell.

19. The method of claim 11 wherein each electrode includes lead.

20. The method of claim 11 wherein the electrolyte includes sulfuric acid.
